(19) United States
(12) Patent Application Publication
(10) Pub. No.: US 2026/0158746 A1
(43) Pub. Date: Jun. 11, 2026

(54) SIMULTANEOUS FILAMENT AND REINFORCEMENT WIRE EXTRUSION FOR ENHANCED 3D PRINTING

(71) Applicant: INTERNATIONAL BUSINESS MACHINES CORPORATION, ARMONK, NY (US)

(72) Inventors: Jeremy R. Fox, Georgetown, TX (US); Martin G. Keen, Cary, NC (US); Sarbajit Kumar Rakshit, Kolkata (IN); Carolina Garcia Delgado, Zapopan (MX)

(21) Appl. No.: 18/976,406

(22) Filed: Dec. 11, 2024

(51) Int. Cl. B29C 64/393; B29C 48/00; B29C 48/02; B29C 48/30; B29C 48/34; B29C 64/118; B29C 64/209; B33Y 10/00; B33Y 30/00; B33Y 50/02

(52) U.S. Cl. CPC B29C 64/393; B29C 48/0022; B29C 48/02; B29C 48/302; B29C 48/34; B29C 64/118; B29C 64/209; B33Y 10/00; B33Y 30/00; B33Y 50/02

(57) ABSTRACT

According to one embodiment, a method, computer system, and computer program product for simultaneous filament and reinforcement wire extrusion for 3D printing is provided. The present invention may include concurrently dispensing a semi-molten primary material and a secondary reinforcement material having a higher melting point than the primary material onto a structure; operating a controlled energy source to sever the secondary reinforcement material during operational scenarios; utilizing computational methodologies to assess flow characteristics of the primary material during deposition; and based on properties of the secondary reinforcement material, determining and regulating preparatory actions for the secondary reinforcement material.

### BACKGROUND

The present invention relates, generally, to the field of computing, and more particularly to additive manufacturing.

The field of additive manufacturing, or 3D printing, relates to a variety of processes whereby three-dimensional objects are constructed by depositing, joining, or solidifying successive layers of material. These processes are controlled by a computer, which constructs the model according to a CAD model or other 3D digital model. Unlike traditional manufacturing, additive manufacturing allows intricate structures to be produced cheaply and accurately, without the need for any more infrastructure than a 3D printer and the materials to feed it. As the precision, consistency, and material range of 3D printing increases, so too does the range of applications, from functional or aesthetic prototyping to industrial production, health, and education.

### SUMMARY

According to one embodiment, a method, computer system, and computer program product for simultaneous filament and reinforcement wire extrusion for 3D printing is provided. The present invention may include concurrently dispensing a semi-molten primary material and a secondary reinforcement material having a higher melting point than the primary material onto a structure; operating a controlled energy source to sever the secondary reinforcement material during operational scenarios; utilizing computational methodologies to assess flow characteristics of the primary material during deposition; and based on properties of the secondary reinforcement material, determining and regulating preparatory actions for the secondary reinforcement material.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary reinforced 3D-printing device according to at least one embodiment;

FIG. 3 illustrates an exemplary reinforced 3D-printing device according to at least one embodiment; and

FIG. 4 is an operational flowchart illustrating a reinforced 3D-printing process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to additive manufacturing. The following described exemplary embodiments provide a system, method, and program product to, among other things, simultaneously print both a filament material and a reinforcement wire during the additive manufacturing process.

As previously described, additive manufacturing relates to a process whereby a manufacturing material is deposited, joined, or solidified layer by layer onto a substrate or previously completed layers to produce a three-dimensional object. One of the key advantages of 3D printing is the ability to produce very complex shapes or geometries that would be otherwise impossible to construct by hand, including hollow parts or parts with internal truss structures to reduce weight.

However, one challenge facing the field of additive manufacturing is the inherent lack of substantial mechanical strength in printed objects, especially when using conventional filament materials. The general weakness of 3D-printed structures can limit the application spectrum of 3D printed objects; for example, additive manufacturing is commonly used for prototyping rather than final end-product manufacturing, due to the inherent small-scale efficiencies of additive manufacturing. However, cutting-edge industries such as aerospace, automotive, medical, and robotics, which move fast and have a particular need to develop new prototypes quickly and cheaply, are also industries where new products or components are required to be both lightweight and robust. Such industries may need to turn to hand-tooling or other more labor-intensive small-scale manufacturing methods to produce prototypes of the required durability, limiting additive manufacturing to industries that require less robust products.

On a similar note, there is a demand in the art for 3D printed complex geometries that can withstand substantial load and stress. Traditional 3D printing processes often involve, for example, successive printing passes or the alteration of material flow patterns to integrate reinforcing structural elements into the object being printed; both methods risk detrimentally impacting the efficiency and finer consistency of the resulting print. As such, it may be advantageous to, among other things, implement a system that simultaneously extrudes filament material and reinforcement wire during the 3D printing process, guided in real-time by a predictive software program improved and refined by feedback and using laser-assisted precision cutting to precisely sever the reinforcement wire, thereby improving the alignment and integration of the wire within the 3D-printed object. Therefore, the present embodiment has the capacity to improve the technical field of additive manufacturing by quickly and cheaply improving the strength of a 3D printed object by seamlessly integrating reinforcement wire into each layer without requiring additional passes, and without degrading the structural integrity of the filament material.

According to one embodiment, the invention is a system for simultaneously extruding filament material and reinforcement wire during a 3D printing process, where the system comprises an additive manufacturing device equipped with a print head comprising a dual-extrusion mechanism, where the dual-extrusion mechanism is enabled to simultaneously dispense both a primary material and a secondary material with a higher melting point than that of the primary material; the dual-extrusion mechanism may heat the materials to a temperature greater than the melting point of the primary material but less than the melting point of the second material such that the primary material is extruded in a semi-molten state to form the main structure of the object being 3D-printed, and the secondary material is extruded in a solid state to provide structural reinforcement to the 3D-printed object. In embodiments, the system may comprise an optical module that is equipped with a camera to observe the 3D object as it is being printed.

In embodiments, the additive manufacturing device may include a cutting module that employs a controlled energy source to sever the secondary reinforcement material during printing operations such as changes in position, changes in direction, or pauses of the print head to ensure integration of the secondary material into the primary material. In embodiments, the cutting module may be integrated into or utilize sensor data from the optical module.

In embodiments, the system may comprise an adaptive control and prediction unit that utilizes computational methodologies to assess, via data from the optical module, the flow characteristics of the primary material in real time during the deposition process. In embodiments, the adaptive control and prediction unit may access a materials database containing properties of various reinforcement materials, and may determine, retrieve, and regulate the preparatory actions required or recommended for the particular secondary material in use by the system; by executing the correct preparatory actions, the adaptive control and prediction unit ensures an extrusion process where both the primary and secondary materials are dispensed in a synchronized manner, thereby improving the structural integrity and quality of the printed object.

According to at least one embodiment, the invention is a method for constructing a 3D-object using a system that simultaneously extrudes filament material and reinforcement wire during a 3D printing process.

References in the specification to “one embodiment,” “other embodiment,” “another embodiment,” “an embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying,” “atop,” “over,” “on,” “positioned on” or “positioned atop” mean that a first element is present on a second element wherein intervening elements, such as an interface structure, may be present between the first element and the second element. The term “direct contact” means that a first element and a second element are connected without any intermediary conducting, insulating, or semiconductor layers at the interface of the two elements.

In the interest of not obscuring the presentation of the embodiments of the present invention, in the following detailed description, some of the processing steps, materials, or operations that are known in the art may have been combined together for presentation and for illustration purposes and in some instances may not have been described in detail. Additionally, for brevity and maintaining a focus on distinctive features of elements of the present invention, description of previously discussed materials, processes, and structures may not be repeated with regard to subsequent Figures. In other instances, some processing steps or operations that are known may not be described. It should be understood that the following description is rather focused on the distinctive features or elements of the various embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to simultaneously print both a filament material and a reinforcement wire during the additive manufacturing process.

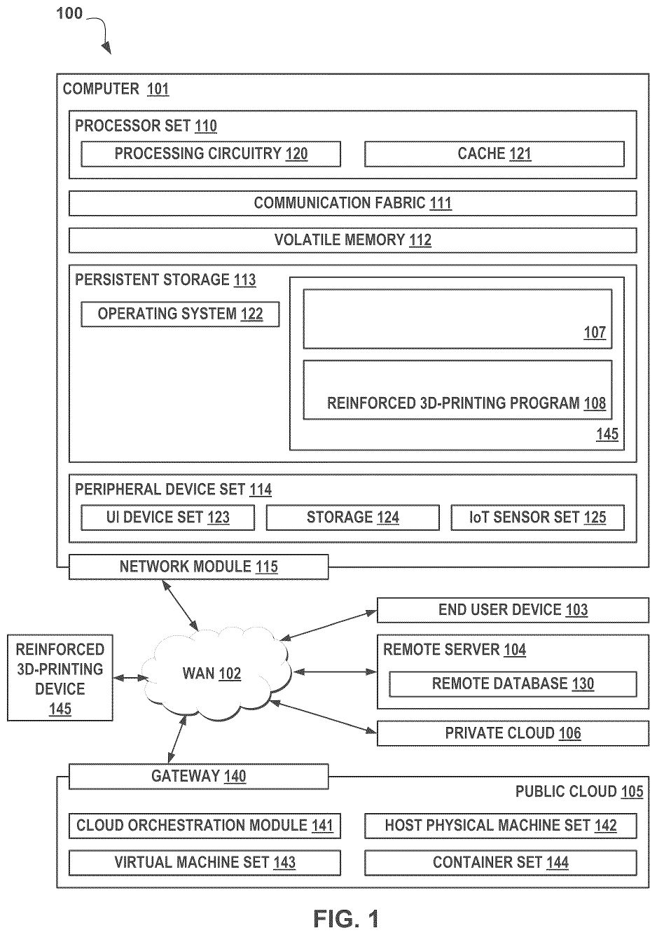

Referring now to FIG. 1, computing environment 100 contains an example of an environment for the execution of at least some of the computer code involved in performing the inventive methods, such as code block 145, which may comprise reinforced 3D-printing program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

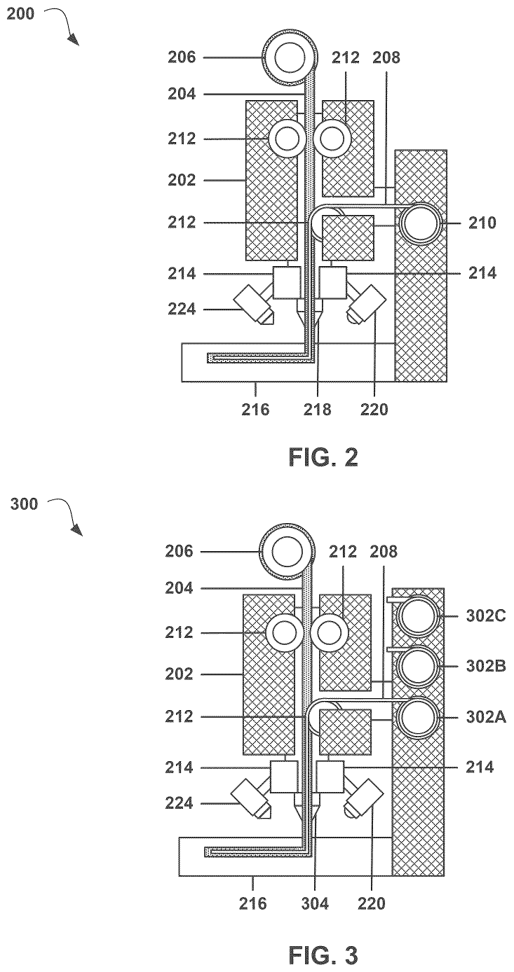

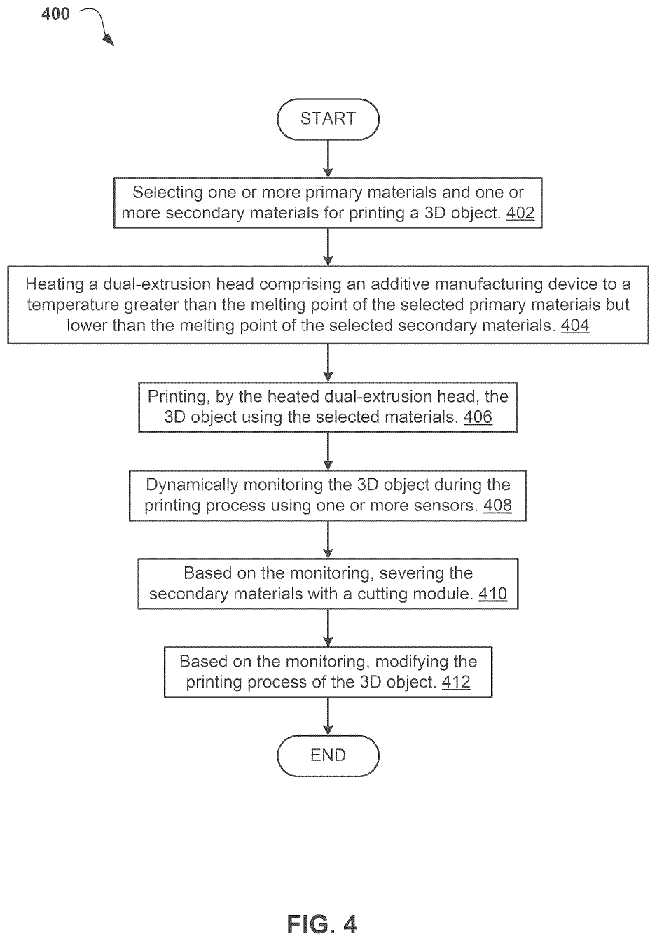

According to the present embodiment, the reinforced 3D-printing device may be an additive manufacturing machine capable of executing a reinforced 3D-printing process to print a three-dimensional object strengthened by a reinforcing material. The reinforced 3D-printing process may be explained in greater detail below with respect to FIG. 4. The reinforced 3D printing device may be equipped with a dual extrusion head, which takes both a primary material and a secondary material and extrudes both materials at the same time such that the secondary material strengthens and reinforces the primary material. The reinforced 3D-printing device may be operated by, receive commands from, or otherwise be in communication with reinforced 3D-printing program 108. The reinforced 3D-printing device may be explained in greater detail below with respect to FIG. 2 and FIG. 3.

According to the present embodiment, the reinforced 3D-printing program 108 may be a

program capable of simultaneously print both a filament material and a reinforcement wire during the additive manufacturing process. The reinforced 3D-printing program 108 may, when executed, cause the computing environment 100 to carry out a reinforced 3D-printing process 200. The reinforced 3D-printing process 200 may be explained in further detail below with respect to FIG. 2. In embodiments of the invention, the reinforced 3D-printing program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, reinforced 3D-printing program 108 may be distributed in its operation over any number or combination of the aforementioned devices.

Referring now to FIG. 2, an exemplary embodiment 200 of a reinforced 3D-printing device 146 is depicted according to at least one embodiment. Here, the reinforced 3D-printing device 146 comprises a dual-extrusion print head 202, which receives a primary material 204 from a primary material filament spool 206, and receives a secondary material 208 from a secondary material filament spool 210; the control system 212 comprises an electromagnetic control system that uses piezoelectric actuators and servomotors to maintain the alignment of the secondary material at the center of nozzle 218. The control system 212 may receive continuous feedback from sensors such as optical module 220 to ensure that the secondary material 208 remains centered within the extruded primary material 204. In embodiments, the control system 212 may initially inject the secondary material 208 into primary material 204 that has been melted by the nozzle 218, and keep the secondary material 208 centered within the melted primary material 204, such that the secondary material 208 within the nozzle 218 is fully surrounded with melted primary material 204 and extruded in such configuration from nozzle 218. The temperature control units 214 maintain a temperature that is higher than the melting point of the primary material, but which is lower than the melting point of the secondary material, such that the primary material is partially melted while the secondary material remains solid. The reinforced 3D-printing program 108 may modify the temperature within that range to create and maintain optimal conditions for extrusion. Once heated, the primary material and secondary material are extruded from the nozzle 218 onto the printer bed 216, or onto previously deposited layers of the 3D-printed object. The extrusion process may be monitored in real time by a camera and/or optical module 220; based on the monitoring, and responsive to the dual-extrusion print head 202 moving in one or more pre-programmed ways, the reinforced 3D-printing program 108 may trigger the cutting module 224 to sever the secondary material using a directed energy source such as a high-powered laser.

Referring now to FIG. 3, an exemplary embodiment 300 of a reinforced 3D-printing device 146 is depicted according to at least one embodiment. Here, the reinforced 3D-printing device 146 comprises a dual-extrusion print head 202, which receives a primary material 204 from a primary material filament spool 206, and receives a secondary material 208 from one of multiple secondary material filament spools 302A, 302B, and 302C; the control system 212 comprises an electromagnetic control system that uses piezoelectric actuators and servomotors to maintain the alignment of the secondary material at the center of adaptive nozzle 304. The adaptive nozzle 304 may be a 3D print head nozzle capable of simultaneously extruding both the primary and secondary materials, and which may be controlled by reinforced 3D-printing program 108 to dynamically modify its aperture to accommodate filaments and wires of different diameters; the adaptive nozzle 304 may adjust its diameter based on selecting primary and secondary materials, for example by improving the size of its aperture to match the combined diameter of the selected primary and selected secondary materials.

The temperature control units 214 maintain a temperature that is higher than the melting point of the primary material, but which is lower than the melting point of the secondary material, such that the primary material is partially melted while the secondary material remains solid. The reinforced 3D-printing program 108 may modify the temperature within that range to create and maintain optimal conditions for extrusion. Once heated, the primary material and secondary material are extruded from the nozzle 218 onto the printer bed 216, or onto previously deposited layers of the 3D-printed object. The extrusion process may be monitored in real time by a camera and/or optical module 220; based on the monitoring, and responsive to the dual-extrusion print head moving in one or more pre-programmed ways, the reinforced 3D-printing program 108 may trigger the cutting module 224 to sever the secondary material. The cutting module 224 may use any method sufficient for cutting a secondary material such as a wire. For example, the cutting module 224 may employ mechanical means such as shears, a directed energy source such as a high-powered laser, et cetera.

Referring now to FIG. 4, an operational flowchart illustrating a reinforced 3D-printing process 400 is depicted according to at least one embodiment. At 402, the reinforced 3D-printing program 108 may select one or more primary materials and one or more secondary materials for printing a 3D object. In embodiments, the reinforced 3D-printing program 108 may utilize computational methodologies to assess a flow characteristics database containing properties of various secondary materials. In other words, the reinforced 3D-printing program 108 can tailor the heat produced by the nozzle 304, the width of the nozzle 304, the feed rate of the primary materials 204 and/or secondary materials 208 into the nozzle 304, et cetera based on the types of filaments and their flow rates, melting points, et cetera, and thereby control the flow rate of material through the nozzle 304 to achieve the desired results with available materials. In embodiments, for example where different diameters of filament are available, the reinforced 3D-printing program 108 may select one or more diameters of filament for the primary and/or secondary materials based on, for example, flow characteristics and/or machine learning models.

In embodiments, the reinforced 3D-printing program 108 may determine and regulate the necessary preparatory actions for the secondary material, ensuring an extrusion process wherein both materials are dispensed in a synchronized manner, thus optimizing the structural integrity and quality of the printed objects of the primary material during deposition. Preparatory actions may include synchronizing, which may include aligning the secondary material within the center of the primary material; preparatory actions may include activating the extrusion of the secondary material, guiding, and aligning secondary material as it is fed into the nozzle during the extrusion process, et cetera. Synchronization may be mirrored based on visual tracking of the wire and filament both being extruded, allowing one to be mapped and matched to the other. Visual tracking may be performed using the optical module using a video camera feedback loop. In embodiments, a sensor besides a visual sensor, such as a laser rangefinder or lidar might be able to perform tracking of the secondary material during synchronization, or a set of two or more different sensors that are paired.

In embodiments, the reinforced 3D-printing program 108 may select two or more wires of the selected secondary material to add to the primary material, thereby providing additional reinforcement and durability to the 3D-printed object.

At 404, the reinforced 3D-printing program 108 may heat a dual-extrusion head comprising an additive manufacturing device to a temperature greater than the melting point of the selected primary materials but lower than the melting point of the selected secondary materials. The reinforced 3D-printing program 108 may identify a temperature to pre-heat the dual-extrusion head 202 to based on the melting points of the selected primary material and secondary material as identified within the flow characteristics database. In embodiments, the reinforced 3D-printing program 108 may further modify the temperature based on flow characteristics identified in the flow characteristics database and/or based on computational fluid dynamics; the reinforced 3D-printing program 108 may assess the flow characteristics of the primary material during printing and identify a temperature that complements the flow of the primary material for synchronized extrusion.

At 406, the reinforced 3D-printing program 108 may print, by the pre-heated dual-extrusion head 202, the 3D object using the selected materials. The reinforced 3D-printing program 108 may print the 3D object by operating the nozzle 218 to concurrently dispense a semi-molten primary material and a secondary material with a higher melting point, thereby ensuring that while the primary material forms the main structure of the 3D object, the secondary material, remains solid due to its intrinsic properties, and provides layer-by-layer reinforcement to enhance the 3D object's structural resilience. The reinforced 3D-printing program 108 may operate the reinforced 3D printing device to build the 3D object layer by layer according to a pre-provided digital model until the 3D object is complete.

In embodiments, the reinforced 3D-printing program 108 may only concurrently dispense both the semi-molten primary material and the secondary reinforcement material to construct specially designated reinforced sections of the 3D object and may otherwise only dispense semi-molten primary material on regular sections. Reinforced sections may be sections of the 3D object where additional strengthening is required through the addition of a secondary reinforcement material. In other words, reinforced sections may represent marked areas for starting and stopping the wire injection to provide for additional strengthening when and where required. Regular sections may be sections of the 3D object where the strength of the primary material is sufficient to support the 3D object. Reinforced and regular sections of the 3D object may be designated within the digital model, or specified by a human user. In embodiments, the reinforced 3D-printing program 108 may automatically designate an area of a 3D model as a reinforced section where the width falls below a threshold thickness and/or where a weight supported by the section exceeds a threshold weight. The threshold thickness and/or the threshold weight may be pre-provided and/or may be based on the strength of the primary material and/or on the strength of the secondary material.

At 408, the reinforced 3D-printing program 108 may dynamically monitor the 3D object during the printing process using one or more sensors. Here, the reinforced 3D-printing program 108 may monitor the 3D object during the 3D printing process using sensors such as optical module 220 to provide real-time feedback on, for example, flow characteristics of the primary material (such as viscosity and ambient temperature) during printing, movements of the print head, location of the secondary material and whether it is centered within the primary material, et cetera.

At 410, the reinforced 3D-printing program 108 may, based on the monitoring, sever the secondary materials with a cutting module 224. The cutting module 224 may comprise a laser cutter capable of quickly heating the secondary material to a temperature exceeding its melting point, thereby severing it. The reinforced 3D-printing program 108 may trigger the cutting module 224 responsive to detecting operational scenarios such as repositioning, directional changes, or pauses, based on the monitoring; in this way, the reinforced 3D-printing program 108 ensures that the secondary material aligns with the 3D printed material and is disconnected from the dual-extrusion head 202 when the dual-extrusion head 202 changes direction or position, ensuring that the secondary material is not dragged or kinked or otherwise disrupted by the movement of the dual-extrusion head 202.

In embodiments, for example where portions of the 3D object are designated as reinforced sections, the reinforced 3D-printing program 108 may inject secondary reinforcement material into the primary material at the beginning of a reinforced section, and may operate the cutting module 224 to sever the secondary reinforcement material at the end of the reinforced section.

At 412, the reinforced 3D-printing program 108 may, based on the monitoring, modify the printing process of the 3D object. The reinforced 3D-printing program 108 may, based on the monitoring, identify problems in the flow characteristics of the primary material, such as an insufficient or excessive flow rate based on high or low viscosity, respectively. In another example, the reinforced 3D-printing program 108 may identify an ambient temperature that is affecting the flow characteristics of the primary material. Responsive to identifying such issues, the reinforced 3D-printing program 108 may perform real-time adjustments to reinforcement wire pre-heating to maintain the flow characteristics of the primary and/or secondary materials within acceptable parameters. In embodiments, the reinforced 3D-printing program 108 may provide the sensor data to a machine learning model, and modify the printing process of the 3D object based on predictive algorithm findings from the machine learning model.

It may be appreciated that FIGS. 2-3 provide only illustrations of individual implementations and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for simultaneous filament and reinforcement wire extrusion for 3D printing, the method comprising:
concurrently dispensing a semi-molten primary material and a secondary reinforcement material having a higher melting point than the primary material onto a structure;
operating a controlled energy source to sever the secondary reinforcement material during operational scenarios;
utilizing computational methodologies to assess flow characteristics of the primary material during deposition; and
based on properties of the secondary reinforcement material, determining, and regulating preparatory actions for the secondary reinforcement material.

2. The method of claim 1, wherein the operational scenarios include repositioning and directional changes of the structure, and pauses in a deposition process.

3. The method of claim 1, wherein a laser severs the secondary reinforcement material during the operational scenarios.

4. The method of claim 1, wherein the secondary material comprises two or more reinforcement wires.

5. The method of claim 1, wherein the primary material and/or secondary material were selected from filaments of multiple different diameters.

6. The method of claim 5, further comprising: modifying a diameter of an adjustable nozzle to accommodate combined diameters of the selected primary material and the selected secondary material.

7. The method of claim 1, modifying a heat of a dual-extrusion print head based on flow characteristics of the semi-molten primary material.

8. A computer system for simultaneous filament and reinforcement wire extrusion for 3D printing, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
concurrently dispensing a semi-molten primary material and a secondary reinforcement material having a higher melting point than the primary material onto a structure;
operating a controlled energy source to sever the secondary reinforcement material during operational scenarios;
utilizing computational methodologies to assess flow characteristics of the primary material during deposition; and
based on properties of the secondary reinforcement material, determining, and regulating preparatory actions for the secondary reinforcement material.

9. The computer system of claim 8, wherein the operational scenarios include repositioning and directional changes of the structure, and pauses in a deposition process.

10. The computer system of claim 8, wherein a laser severs the secondary reinforcement material during the operational scenarios.

11. The computer system of claim 8, wherein the secondary material comprises two or more reinforcement wires.

12. The computer system of claim 8, wherein the primary material and/or secondary material were selected from filaments of multiple different diameters.

13. The computer system of claim 12, further comprising: modifying a diameter of an adjustable nozzle to accommodate combined diameters of the selected primary material and the selected secondary material.

14. The computer system of claim 8, modifying a heat of a dual-extrusion print head based on flow characteristics of the semi-molten primary material.

15. A computer program product for simultaneous filament and reinforcement wire extrusion for 3D printing, the computer program product comprising:
one or more computer-readable tangible storage medium and program instructions stored on at least one of the one or more tangible storage medium, the program instructions executable by a processor to cause the processor to perform a method comprising:
concurrently dispensing a semi-molten primary material and a secondary reinforcement material having a higher melting point than the primary material onto a structure;
operating a controlled energy source to sever the secondary reinforcement material during operational scenarios;
utilizing computational methodologies to assess flow characteristics of the primary material during deposition; and
based on properties of the secondary reinforcement material, determining, and regulating preparatory actions for the secondary reinforcement material.

16. The computer program product of claim 15, wherein the operational scenarios include repositioning and directional changes of the structure, and pauses in a deposition process.

17. The computer program product of claim 15, wherein a laser severs the secondary reinforcement material during the operational scenarios.

18. The computer program product of claim 15, wherein the secondary material comprises two or more reinforcement wires.

19. The computer program product of claim 15, wherein the primary material and/or secondary material were selected from filaments of multiple different diameters.

20. The computer program product of claim 19, further comprising: modifying a diameter of an adjustable nozzle to accommodate combined diameters of the selected primary material and the selected secondary material.
